(19) United States
(12) Patent Application Publication
(10) Pub. No.: US 2012/0075594 A1
(43) Pub. Date: Mar. 29, 2012

(54) PROJECTION APPARATUS AND ILLUMINATION SYSTEM

(75) Inventors: Chih-Hsien Tsai, Hsinchu (TW); Chien-Jung Huang, Hsinchu (TW); Pei-Ching Liu, Hsinchu (TW); Yu-Tsung Lee, Hsinchu (TW); Yi-Hao Kang, Hsinchu (TW); Chi-Tang Hsieh, Hsinchu (TW)

(73) Assignee: YOUNG OPTICS INC., Hsinchu (TW)

(21) Appl. No.: 13/157,335

(22) Filed: Jun. 10, 2011

(30) Foreign Application Priority Data
Sep. 24, 2010 (TW) 99132444

(51) Int. Cl. G03B 21/14

(52) U.S. Cl. 353/38

(57) ABSTRACT

A projection apparatus including a light source, a light uniforming and shaping module, and a light valve is provided. The light source has a light-emitting surface and is capable of emitting an illumination beam. The light uniforming and shaping module is disposed on a transmission path of the illumination beam. The light valve is disposed on a projection surface and on the transmission path of the illumination beam from the light uniforming and shaping module, wherein the light valve is capable of converting the illumination beam into an image beam. The light uniforming and shaping module is for projecting a light from each point of the light-emitting surface to a region on the projection surface, and the union of the regions projected from all the points on the light-emitting surface covers an entire active surface of the light valve. An illumination system is also provided.

### CROSS-REFERENCE TO RELATED APPLICATION

This application claims the priority benefit of Taiwan application serial no. 99132444, filed on Sep. 24, 2010. The entirety of the above-mentioned patent application is hereby incorporated by reference herein and made a part of this specification.

### BACKGROUND OF THE INVENTION

1. Field of the Invention

The invention generally relates to an optical apparatus, and more particularly, to a projection apparatus and an illumination system.

2. Description of Related Art

A light emitting diode (LED) is a highly directional light source having microstructures on a surface thereof (e.g., wire bonds or metal electrodes), and thus in conventional techniques, a first plano-convex lens array and a second plano-convex lens array are required to uniformly image the light source emitted from the LED on the active surface of the light valve, and to lower the effect on the light emitting uniformity thereof due to the LED's microstructures.

In conventional techniques, the aforementioned first and second plano-convex lens arrays have a plurality of identical plano-convex lenses arranged in array. Each of the plano-convex lenses on the first lens array corresponds one-to-one with each of the plano-convex lenses on the second lens array.

When a light is incident upon a plano-convex lens of the first plano-convex lens array at a large angle, the light emerges from a plano-convex lens of the first plano-convex lens array at a large angle. Moreover, the light ray does not enter the corresponding plano-convex lens in the second plano-convex lens array. Therefore, the light emerges from the second plano-convex lens array at an overly large angle. Accordingly, when a light is incident upon the first plano-convex lens array at a large angle, the light cannot be projected on the active surface of the light valve. In other words, the light not being utilized by the light valve results in a light energy loss of the LED. Moreover, a light energy loss of the LED also occurs when the first and second plano-convex lens arrays have an abnormal positioning therebetween.

U.S. Pat. No. 7,016,393 discloses an apparatus for projecting line of light, in which the light emitted from a diode-laser array can form overlapping elongated images through a function of the optical system thereof. U.S. Pat. No. 7,185,985 discloses an illumination apparatus, in which after a light emitted by an LED serving as a planar light source is acted on by a conical rod and a lens, the light can be uniformly incident upon an optical modulation element.

### SUMMARY OF THE INVENTION

Accordingly, the invention is directed to a projection apparatus capable of reducing a light energy loss.

Moreover, the invention is directed to an illumination system capable of reducing a light energy loss.

Other objects and advantages of the invention could be further comprehended from the technical features disclosed in the invention.

In order to achieve one or a portion of or all of the objects or other objects, an embodiment of the invention provides a projection apparatus including a light source, a light uniforming and shaping module, and a light valve. The light source has a light-emitting surface and is capable of emitting an illumination beam. The light uniforming and shaping module is disposed on a transmission path of the illumination beam. The light valve is disposed on a projection surface and in the transmission path of the illumination beam from the light uniforming and shaping module, wherein the light valve is capable of converting the illumination beam into an image beam. The light uniforming and shaping module is for projecting a light from each point of the light-emitting surface to a region on the projection surface, and the union of the regions projected from all the points on the light-emitting surface covers a whole active surface of the light valve.

Another embodiment of the invention provides an illumination system capable of illuminating a light valve on a projection surface. The illumination system includes a light source and a light uniforming and shaping module. The light source has a light-emitting surface and is capable of emitting an illumination beam. The light uniforming and shaping module is disposed on a transmission path of the illumination beam so as to project the illumination beam on the light valve. The light uniforming and shaping module is for projecting a light from each point of the light-emitting surface to a region on the projection surface, and the union of the regions projected from all the points on the light-emitting surface covers a whole active surface of the light valve.

In view of the foregoing, the embodiments of the invention include at least the following advantages or effects. In the projection apparatus and the illumination system according to the embodiments of the invention, a light uniforming and shaping module is disposed. The light uniforming and shaping module could uniformly and efficiently project the light beam emitted by the light source on the active surface of the light valve, and thereby effectively decrease the light energy loss.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1, 8, 9, 10, 14, and 15 are schematic views of a projection apparatus according to an embodiment of the invention.

FIGS. 2A and 2B are schematic views of an LED light source according to an embodiment of the invention.

FIG. 3 is a schematic view of a light-emitting surface beam shape according to an embodiment of the invention.

FIGS. 4, 11, 16, 19, and 20 are schematic views of a beam shape according to an embodiment of the invention.

FIGS. 5, 6, and 12 are schematic views of an optical path from a light uniforming and shaping module to a light valve according to an embodiment of the invention.

FIG. 7 is a schematic top view of a lens array according to an embodiment of the invention.

FIG. 13 is a schematic top view of a plurality of solid light integration rods according to an embodiment of the invention.

FIGS. 17 and 18 are schematic views of an optical path from a light source to a light valve according to an embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention could be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### First Embodiment

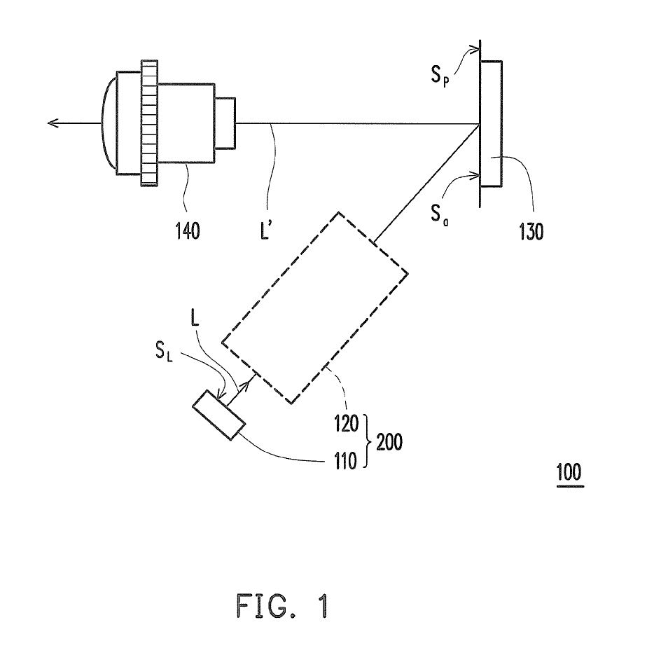

FIG. 1 is a schematic view of a projection apparatus according to an embodiment of the invention. Referring to FIG. 1, a projection apparatus 100 of the present embodiment includes a light source 110, a light uniforming and shaping module 120, and a light valve 130. In the embodiment, the light source 110 has a light-emitting surface SL and is capable of emitting an illumination beam L. The light uniforming and shaping module 120 is disposed on a transmission path of the illumination beam L. The light valve 130 is disposed on a projection surface Sp and on the transmission path of the illumination beam L from the light uniforming and shaping module 120, in which the light valve 130 is capable of converting the illumination beam L into an image beam L′. For example, at least a part of the illumination beam L is reflected as the image beam L′. Moreover, the projection apparatus 100 of the present embodiment may further include a projection lens 140 disposed on a transmission path of the image beam L′, and the projection lens 140 is for projecting the image beam L′ on a display screen.

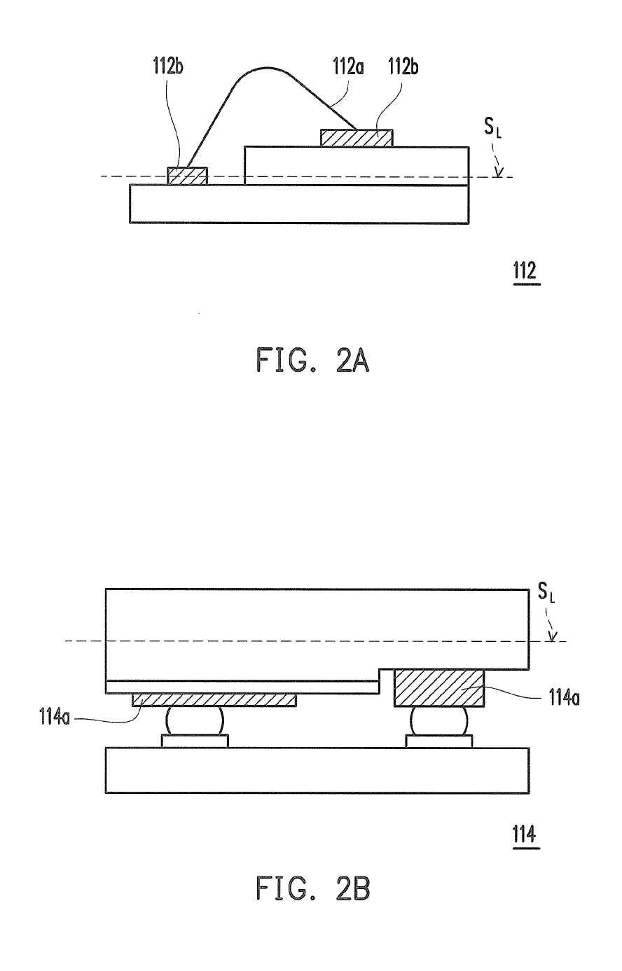

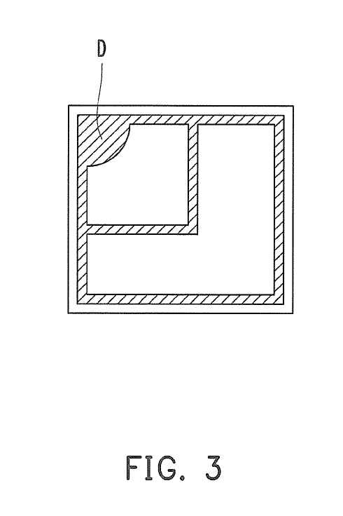

In the embodiment, the light source 110 is, for example, a light emitting diode (LED) device. The LED device may be, for example, a wire bonding type LED device 112 depicted in FIG. 2A. The light source 110 may also be a flip chip bonding type LED device 114 depicted in FIG. 2B. In the wire bonding type LED device 112, the light-emitting surface SL has microstructures such as a wire bond 112a and an opaque metal electrode 112b thereon, as shown in FIG. 2A, and thus the beam shape emitted by the light-emitting surface SL thereof is not a complete rectangular shape, but rather a beam shape having an obvious defect area D, as shown in FIG. 3. On the other hand, in the flip chip bonding type LED device 114, the microstructures such as a wire bond and an opaque metal electrode 114a are disposed underneath the light-emitting surface SL. Therefore, the effect on the beam shape emitted from the light-emitting surface SL due to these microstructures such as the wire bond and the opaque metal electrode 114a is less significant. In other words, the defect area of the beam shape emitted by the light-emitting surface SL of the flip chip bonding type LED device 114 is less apparent. However, the invention should not be construed as limited thereto, and the light source 110 may also be other suitable light sources.

In the present embodiment, the light uniforming and shaping module 120 is for projecting a light from each point of the light-emitting surface SL to a region on the projection surface Sp, in which the light from each point of the light-emitting surface SL is projected to an area of 40,000 or more μm2 on the projection surface Sp. Moreover, a union of the regions projected from all the points on the light-emitting surface SL covers a whole active surface Sa of the light valve 130.

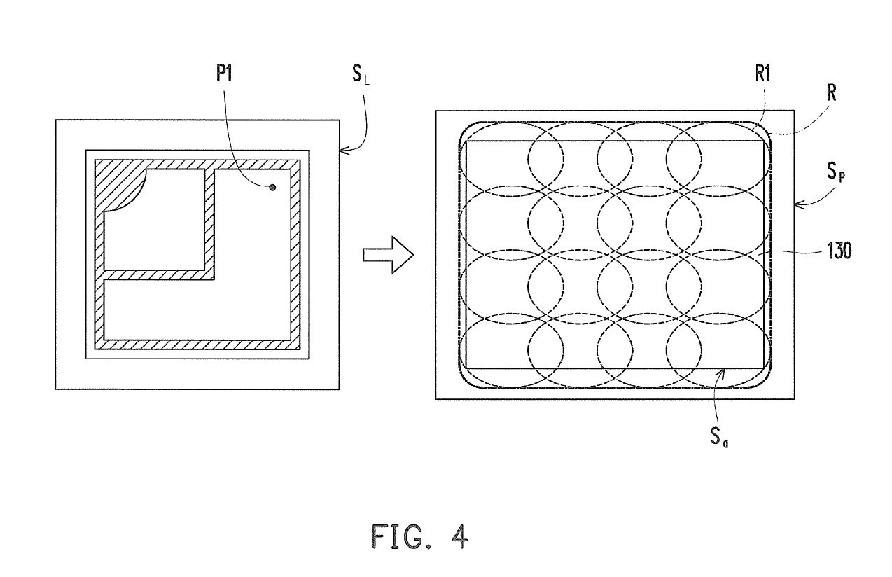

For example, referring to both FIGS. 1 and 4, the illumination beam L emitted from a point P1 on the light-emitting surface SL may be projected on the projection surface Sp by the light uniforming and shaping module 120. Moreover, the light emitted from the point P1 on the light-emitting surface SL is projected to a region R1 of the projection surface Sp, and the area of the region R1 is 40,000 or more μm2. Similarly, other points on the light-emitting surface SL each may also be projected on a region of the projection surface Sp by the light uniforming and shaping module 120, and the area of the region is also 40,000 or more μm2. A union R of the regions projected on the projection surface Sp from all the points on the light-emitting surface SL covers the entire active surface Sa of the light valve 130. In other words, the light uniforming and shaping module 120 employs a non-imaging method to project the illumination beam L on the entire active surface Sa of the light valve 130.

It should be noted that, each point on the light-emitting surface SL is diffused into a region on the projection surface Sp having an area of 40,000 or more μm2 by the light uniforming and shaping module 120, and at least adjacent regions overlap with each other. Therefore, when the light source 110 is, for example, the flip chip bonding type LED device 114, the defect area of the beam shape emitted by the light-emitting surface SL is effectively reduced. Moreover, the illumination beam L emitted by the light-emitting surface SL forms a uniform light energy distribution on the projection surface Sp. Accordingly, the illumination beam L emitted by the light-emitting surface SL becomes more preferably suitable for use by the light valve 130 on the projection surface Sp. In addition, the image quality projected by the projection apparatus 100 of the present embodiment is better.

When the light source 110 is, for example, the wire bonding type LED device 112, the defect area D of the beam shape of the light-emitting surface SL is more apparent than the flip chip bonding type LED device 114. Therefore, the light uniforming and shaping module 120 may be suitably designed such that the light from each point of the light-emitting surface SL is projected to an area of greater than or equal to 25,0000 μm2 on the projection surface Sp by the light uniforming and shaping module 120. Accordingly, the illumination beam L emitted from each point on the light-emitting surface SL of the wire bonding type LED device 112 may form a uniform light intensity distribution on the projection surface Sp and cover the whole active surface Sa of the light valve 130, which is more preferably suitable for use by the light valve 130 on the projection surface Sp. In an embodiment of the invention, the light uniforming and shaping module 120 may be suitably designed, such that each point on the light-emitting surface SL is projected by the light uniforming and shaping module 120 to an area on the projection surface Sp covering the whole active surface Sa of the light valve 130, so as to achieve a more uniform illumination effect.

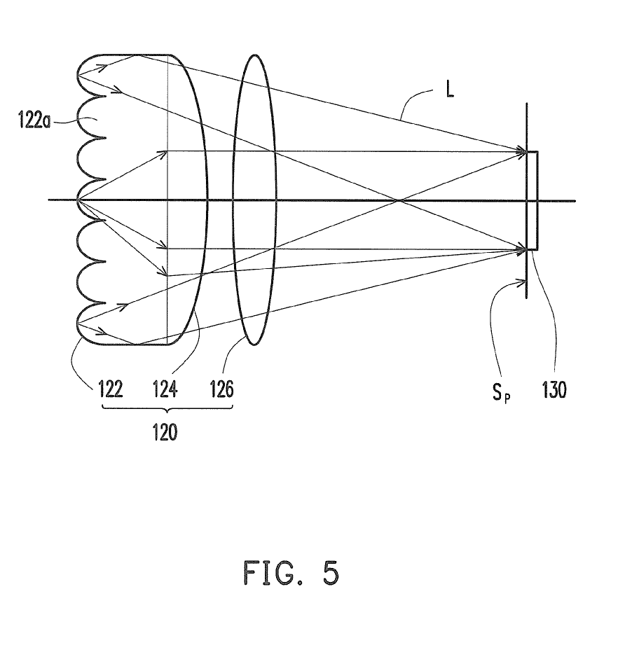

FIG. 5 is a schematic view of an optical path from a light uniforming and shaping module to a light valve according to an embodiment of the invention. In the present embodiment, the light uniforming and shaping module 120 includes a lens array 122 and a lens 124. In the embodiment, the lens array 122 is disposed on the transmission path of the illumination beam L and between the light source 110 and the light valve 130. The lens 124 is disposed on the transmission path of the illumination beam L and between the light source 110 and the light valve 130. More specifically, the lens 124 is disposed on the transmission path of the illumination beam L and between the lens array 122 and the light valve 130. Moreover, a distance from the lens array 122 to the lens 124 is less than a distance from the lens 124 to the light valve 130. In the embodiment, there is no light integration rod or another lens array disposed on the transmission path of the illumination beam L between the lens array 122 and the lens 124. Moreover, the lens array 122 and the lens 124 project the illumination beam L on the light valve 130 by a non-imaging method.

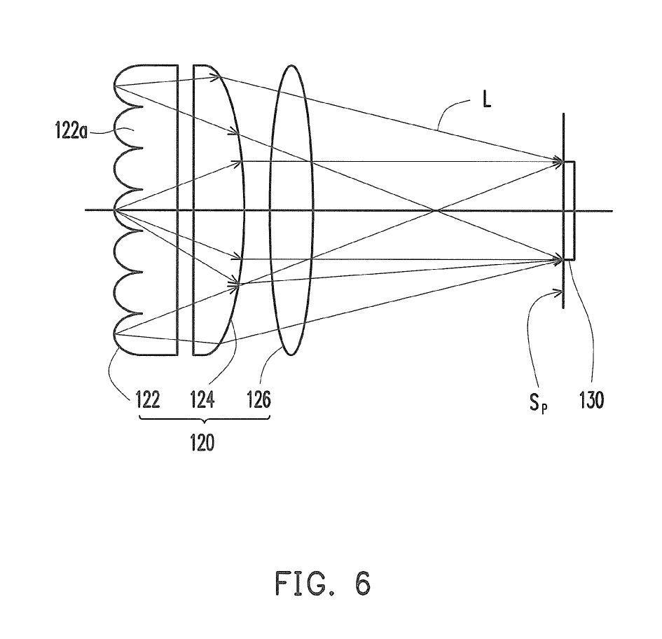

In the present embodiment, the lens array 122 and the lens 124 may be integrally formed or separately formed, as shown respectively in FIGS. 5 and 6, although the invention is not limited thereto. It should be noted that, the lens array 122 and the lens 124 have a simple structure and a low production cost, along with a low precision requirement for the positioning of the lens array 122 and the lens 124. Accordingly, the precise positioning of the two lens arrays in the conventional techniques is not required.

Moreover, the light uniforming and shaping module 120 of the present embodiment may further include a lens 126 disposed on the transmission path of the illumination beam L and between the lens 124 and the light valve 130. In the embodiment, the lens 126 is, for example, a spherical lens or an aspherical lens.

In the present embodiment, the illumination beam L diffused by the lens array 122 may be effectively collected by the lens 124. Further, the direction of the illumination beam L could be changed by the lens 126 and projected on the projection surface Sp, for example as shown in FIGS. 5 and 6. Accordingly, the light uniforming and shaping module 120 of the present embodiment may diffuse the light emitted from each point on the light-emitting surface SL and project the light to a region on the projection surface Sp.

It should be noted that, the lens 124 may effectively collect the illumination beam L diffused by the lens array 122, thereby projecting a majority of the illumination beam L emitted from the light-emitting surface SL to the active surface Sa of the light valve 130, for use by the light valve 130. In other words, the lens 124 may effectively lower the occurrence of projecting the illumination beam L to a region outside of the active surface Sa of the light valve 130. Namely, the lens 124 could make the illumination beam L emitted from the light source 110 be more efficiently utilized, and thereby lower the energy loss of the light source 110.

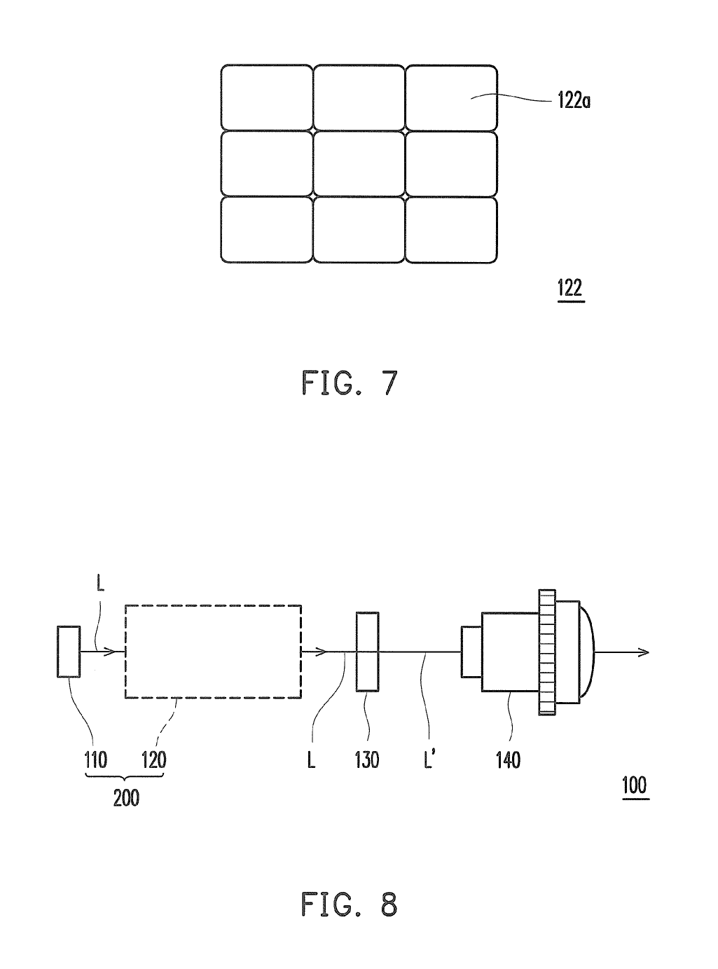

Besides expanding the light emitted from each point of the light-emitting surface SL and uniformly projecting the light on the projection surface Sp, the light uniforming and shaping module 120 of the present embodiment could also reshape the beam shape emitted by the light-emitting surface SL. Accordingly, the beam shape outputted by the light uniforming and shaping module 120 on the projection surface Sp approaches the shape of the active surface Sa of the light valve 130. More specifically, FIG. 7 is a top view of the lens array 122 in the light uniforming and shaping module 120 according to an embodiment of the invention. As shown clearly in FIG. 7, in the lens array 122 of the present embodiment, each of the lenses 122a is connected with each other, and the lens array 122 has a rectangular shape. Therefore, the rectangular shape lens array 122 may reshape the beam shape emitted by the light-emitting surface SL into a shape approaching the rectangular shape of the light valve 130 and covering the entire active surface Sa of the light valve 130, as shown in FIG. 4.

In the present embodiment, the light valve 130 is, for example, a digital micromirror device (DMD), a liquid-crystal-on-silicon (LCOS) or transmissive liquid crystal display (LCD). The shape of the light valve 130 is, for example, rectangular, although the invention is not limited thereto. The shape of the light valve 130 may be suitably adjusted according to a practical requirement. When the shape of the light valve 130 is adjusted, the shape of the reshaping element (e.g., the lens array 122) in the light uniforming and shaping module 120 may also be adjusted correspondingly. It should be noted that, when the light valve 130 is a transmissive light valve such as a transmissive LCD, the configuration of each element in the projection apparatus 100 needs to be suitably adjusted, for example as shown in FIG. 8.

Referring to FIGS. 1 and 8, an illumination system 200 of the present embodiment is capable of illuminating the light valve 130 on the projection surface SP. In the embodiment, the illumination system 200 includes the aforementioned light source 110 and the light uniforming and shaping module 120. The illumination system 200 has the effects and advantages of the light source 110 and the light uniforming and shaping module 120. The light valve 130 is capable of modulating the illumination beam L so that the illumination beam L passing through the light valve forms the image beam L′.

### Second Embodiment

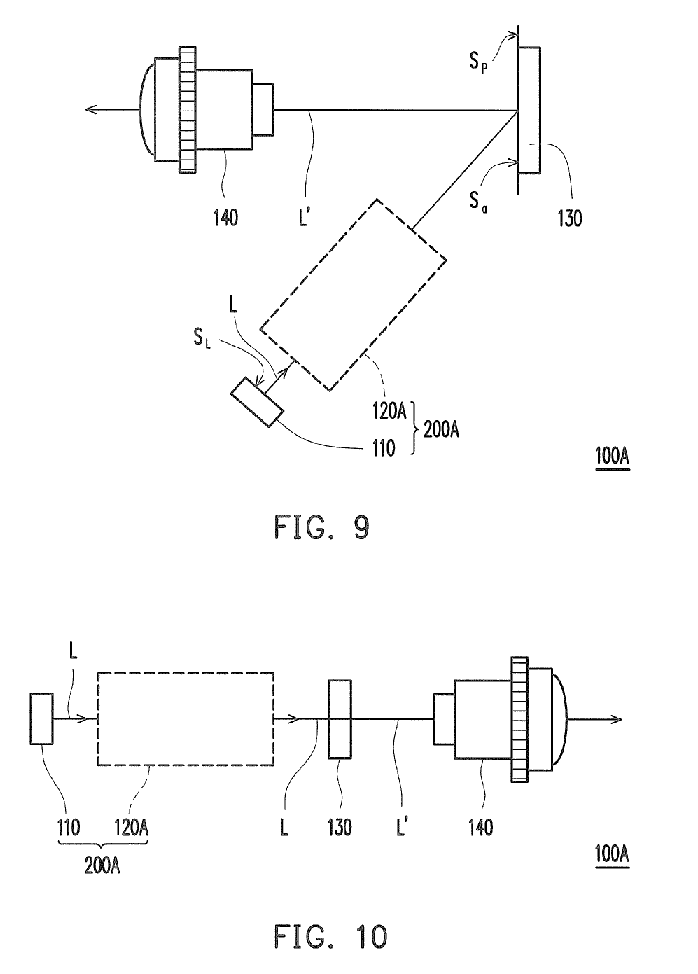

FIGS. 9 and 10 are schematic views of a projection apparatus according to an embodiment of the invention. Referring to FIGS. 9 and 10, a projection apparatus 100A of the present embodiment is similar to the projection apparatus 100 of the first embodiment, and the projection apparatus 100A is capable of achieving similar effects as the projection apparatus 100 of the first embodiment. In the present embodiment, a light uniforming and shaping module 120A in the projection apparatus 100A is different from the light uniforming and shaping module 120 of the first embodiment. The difference is further illustrated hereafter, with the similar parts thereof omitted from further description.

In the present embodiment, the light uniforming and shaping module 120A is also for projecting a light from each point of the light-emitting surface SL of the light source 110 to a region on the projection surface Sp, in which the light from each point of the light-emitting surface SL is projected to an area of 40,000 or more μm2 on the projection surface Sp. Moreover, the union of the regions projected from all the points on the light-emitting surface SL covers the entire active surface Sa of the light valve 130.

For example, referring to both FIGS. 9 (or 10) and 11, the illumination beam L emitted from a point P2 on the light-emitting surface SL may be projected on the projection surface Sp by the light uniforming and shaping module 120A. Moreover, the light emitted from the point P2 on the light-emitting surface SL is projected to a region R2 of the projection surface Sp, and the area of the region R2 is greater than or equal to 40,000 μm2. Similarly, other points on the light-emitting surface SL each may also be projected on a region of the projection surface Sp by the light uniforming and shaping module 120A, and the area of the region is also 40,000 or more μm2. A union R of the regions projected on the projection surface Sp from all the points on the light-emitting surface SL covers the whole active surface Sa of the light valve 130. In other words, the light uniforming and shaping module 120A employs a non-imaging method to project the illumination beam L on the entire active surface Sa of the light valve 130.

It should be noted that, each point on the light-emitting surface SL is diffused into a region on the projection surface Sp having an area greater than or equal to 40,000 μm2 by the light uniforming and shaping module 120A, and at least adjacent regions overlap with each other. Therefore, when the light source 110 is, for example, the flip chip bonding type LED device 114, the defect area of the beam shape emitted by the light-emitting surface SL on the projection surface Sp is effectively reduced. Moreover, the illumination beam L emitted by the light-emitting surface SL forms a uniform light energy distribution on the projection surface Sp. Accordingly, the illumination beam L emitted by the light-emitting surface SL becomes more preferably suitable for use by the light valve 130 on the projection surface Sp. In addition, the image quality projected by the projection apparatus 100A of the present embodiment is preferred.

When the light source 110 is, for example, the wire bonding type LED device 112, the defect area D of the beam shape of the light-emitting surface SL is more apparent than the flip chip bonding type LED device 114. Therefore, the light uniforming and shaping module 120A may be suitably designed, such that the light from each point of the light-emitting surface SL is projected to an area of preferably greater than or equal to 25,0000 μm2 on the projection surface Sp by the light uniforming and shaping module 120A. Accordingly, the illumination beam L emitted from each point on the light-emitting surface SL of the wire bonding type LED device 112 may form a uniform light intensity distribution on the projection surface Sp covering the entire active surface Sa of the light valve 130, which is more preferably suitable for use by the light valve 130 on the projection surface Sp. In an embodiment of the invention, the light uniforming and shaping module 120A may also be suitably designed, such that each point on the light-emitting surface SL is projected by the light uniforming and shaping module 120A to an area on the projection surface Sp covering the entire active surface Sa of the light valve 130, so as to achieve a more uniform illumination effect.

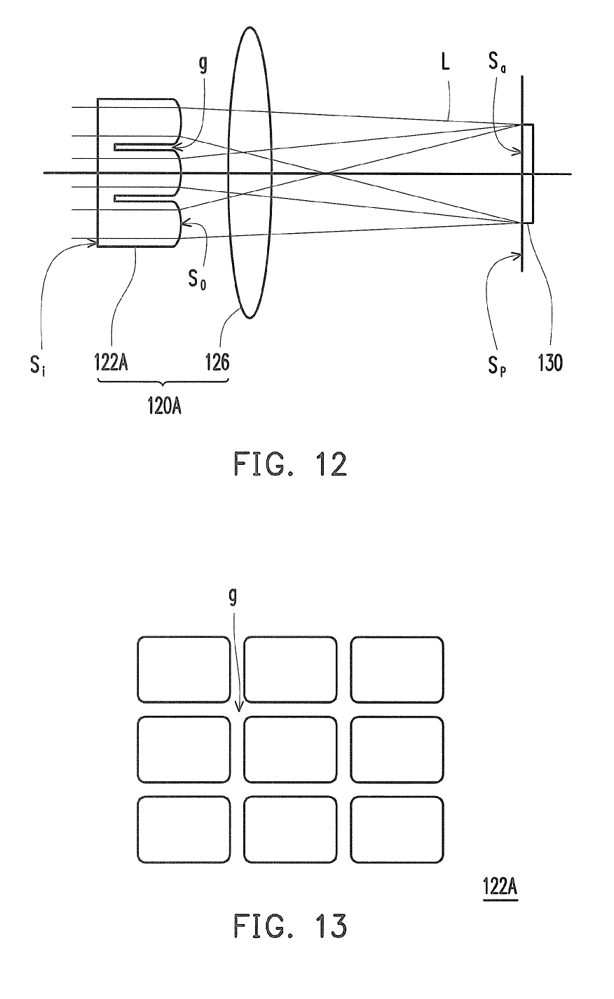

FIG. 12 is a schematic view of an optical path from a light uniforming and shaping module to a light valve according to an embodiment of the invention. Referring to both FIG. 9 (or FIG. 10) and FIG. 12, the light uniforming and shaping module 120A of the present embodiment may, for example, include a plurality of solid light integration rods 122A. The solid light integration rods 122A are arranged in an array and disposed on the transmission path of the illumination beam L and between the light source 110 and the light valve 130. Each of the solid light integration rods has an incident end Si and an emitting end So opposed to each other. The illumination beam L enters the solid light integration rod 122A from the incident end Si, and leaves the solid light integration rod 122A from the emitting end So. The emitting end So of each of the solid light integration rods 122A has a curved surface.

It should be noted that, the solid light integration rods 122A are connected to each other at the incident end Si and separated from each other at the other portions, and a gap g exists therebetween, as shown in FIG. 12.

The light uniforming and shaping module 120A of the present embodiment may further include a lens 126. The lens 126 is disposed on the transmission path of the illumination beam L and between the solid light integration rods 122A and the light valve 130. Moreover, a distance from the solid light integration rods 122A to the lens 126 is less than a distance from the lens 126 to the light valve 130.

In the embodiment, the plurality of the solid light integration rods 122A may reshape and uniform the illumination beam L emitted from each point on the light-emitting surface SL. Moreover, the direction of the illumination beam L is changed by the lens 126 and projected on the projection surface Sp, for example as shown in FIG. 12.

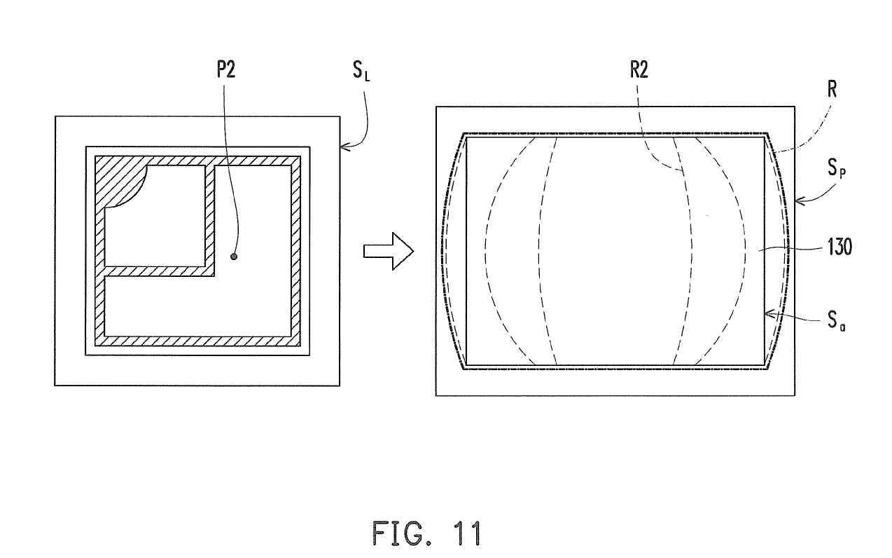

Besides expanding the light emitted from each point of the light-emitting surface SL and uniformly projecting the light on the projection surface Sp, the light uniforming and shaping module 120A of the present embodiment could also reshape the beam shape emitted by the light-emitting surface SL. Accordingly, the beam shape outputted by the light uniforming and shaping module 120A on the projection surface Sp approaches the shape of the active surface Sa of the light valve 130. Specifically, FIG. 13 is a schematic front view of a plurality of solid light integration rods 122A according to an embodiment of the invention. FIG. 13 clearly shows the shape of an array (e.g., a 3×2 array) formed by the solid light integration rods 122A is rectangular. Therefore, the beam shape emitted by the light-emitting surface SL may be reshaped by the solid light integration rods 122A arranged into the rectangular shaped array, into a shape approaching the rectangular shape of the light valve 130 and covering the entire active surface Sa of the light valve 130, as shown in FIG. 11. Accordingly, the illumination beam L emitted by the light-emitting surface SL may be more efficiently utilized by the light valve 130 on the projection surface Sp.

Referring to FIGS. 9 and 10, an illumination system 200A of the present embodiment is capable of illuminating the light valve 130 on the projection surface SP. In the embodiment, the illumination system 200A includes the aforementioned light source 110 and the light uniforming and shaping module 120A. The illumination system 200A has the effects and advantages of the light source 110 and the light uniforming and shaping module 120A.

### The Third Embodiment

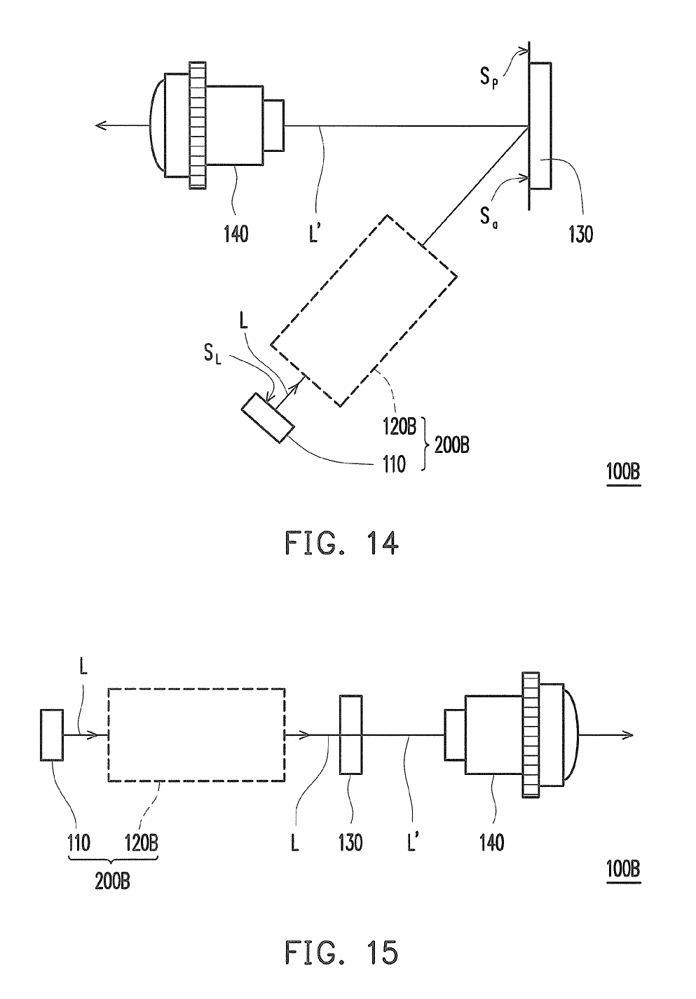

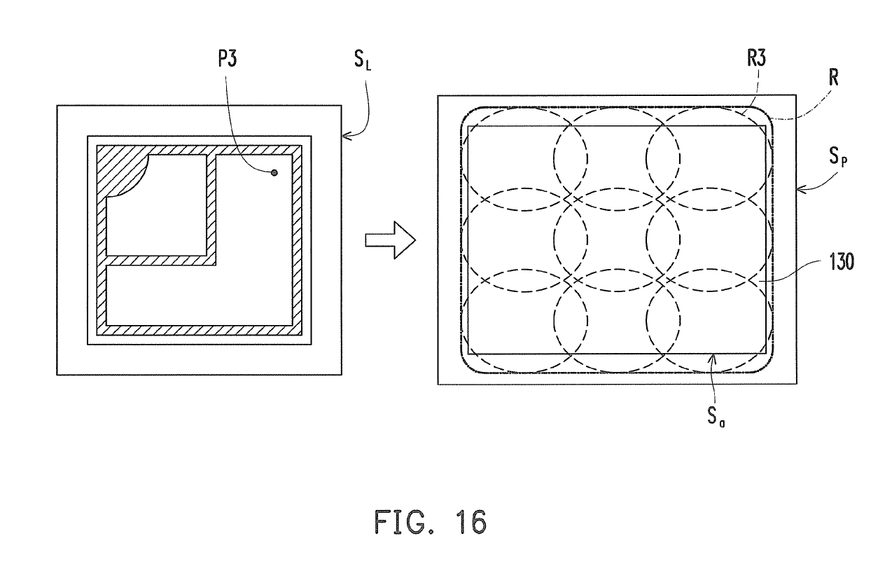

FIGS. 14 and 15 are schematic views of a projection apparatus according to an embodiment of the invention. Referring to FIGS. 14 and 15, a projection apparatus 100B of the present embodiment is similar to the projection apparatus 100 of the first embodiment, and the projection apparatus 100B is capable of achieving similar effects as the projection apparatus 100 of the first embodiment. In the present embodiment, a light uniforming and shaping module 120B in the projection apparatus 100B is different from the light uniforming and shaping module 120 of the first embodiment. The difference is further illustrated hereafter, with the similar parts thereof omitted from further description.

Referring to both FIGS. 14 and 15, the light uniforming and shaping module 120B of the present embodiment is for projecting a light from each point of the light-emitting surface SL to a region on the projection surface Sp, in which the light from each point of the light-emitting surface SL is projected to an area of 40,000 or more μm2 on the projection surface Sp. Moreover, the union of the regions projected from all the points on the light-emitting surface SL covers the entire active surface Sa of the light valve 130.

For example, referring to both FIGS. 14 (or FIG. 15) and 16, the illumination beam L emitted from a point P3 on the light-emitting surface SL may be projected on the projection surface Sp by the light uniforming and shaping module 120B. Moreover, the light emitted from the point P3 on the light-emitting surface SL is projected to a region R3 of the projection surface Sp, and the area of the region R3 is greater than or equal to 40,000 μm2. Similarly, other points on the light-emitting surface SL each may also be projected on a region of the projection surface Sp by the light uniforming and shaping module 120B, and the area of the region is also greater than or equal to 40,000 μm2. A union R of the regions projected on the projection surface Sp from all the points on the light-emitting surface SL covers the entire active surface Sa of the light valve 130. In other words, the light uniforming and shaping module 120B employs a non-imaging method to project the illumination beam L on the entire active surface Sa of the light valve 130.

It should be noted that, each point on the light-emitting surface SL is diffused into a region on the projection surface Sp having an area greater than or equal to 40,000 μm2 by the light uniforming and shaping module 120B, and at least adjacent regions overlap with each other. Therefore, when the light source is, for example, the flip chip bonding type LED device 114, the defect area of the beam shape emitted by the light-emitting surface SL on the projection surface Sp is effectively reduced. Moreover, the illumination beam L emitted from each point on the light-emitting surface SL forms a uniform light energy distribution on the projection surface Sp and covers the whole active surface Sa of the light valve 130. Accordingly, the illumination beam L emitted by the light-emitting surface SL becomes more preferably suitable for use by the light valve 130 on the projection plane Sp. In addition, the image quality projected by the projection apparatus 100B of the present embodiment is preferred.

When the light source 110 is, for example, the wire bonding type LED device 112, the defect area D of the beam shape of the light-emitting surface SL is more apparent than the flip chip bonding type LED device 114. Therefore, the light uniforming and shaping module 120B may be suitably designed, such that a light from each point of the light-emitting surface SL is projected to an area of preferably greater than or equal to 25,0000 μm2 on the projection surface Sp by the light uniforming and shaping module 120B. Accordingly, the illumination beam L emitted from each point on the light-emitting surface SL of the wire bonding type LED device 112 may form a uniform light intensity distribution on the projection surface Sp and cover the entire active surface Sa of the light valve 130, which is more preferably suitable for use by the light valve 130 on the projection plane Sp. In an embodiment of the invention, the light uniforming and shaping module 120B may also be suitably designed, such that each point on the light-emitting surface SL is projected by the light uniforming and shaping module 120B to an area on the projection surface Sp covering the whole active surface Sa of the light valve 130, so as to achieve a more uniform illumination effect.

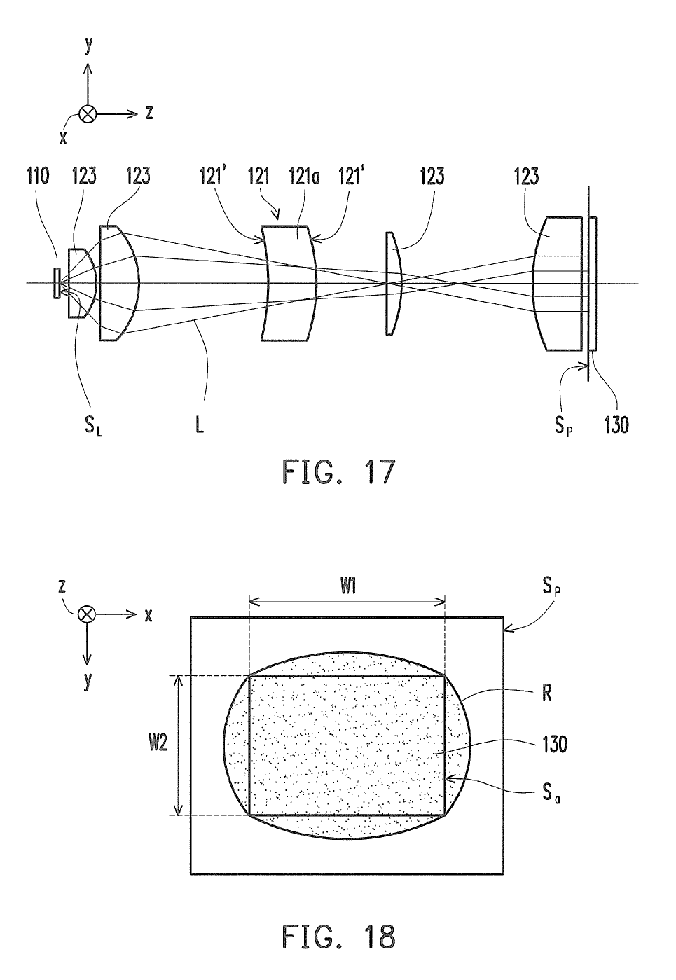

FIG. 17 is a schematic view of an optical path (looking towards the x-direction) from a light source to a light valve according to an embodiment of the invention. FIG. 18 is also a schematic view of an optical path from a light source to a light valve according to an embodiment of the invention, with a difference from FIG. 17 being that FIG. 18 is a schematic view of the optical path looking towards the z-direction. The light uniforming and shaping module 120B of the present embodiment includes a freeform lens group 121, in which a refractive power of the freeform lens group 121 on a first direction (e.g., the x-direction) is not equal to a refractive power of the freeform lens group 121 on a second direction (e.g., the y-direction). The first direction is substantially perpendicular to the second direction, the first direction is substantially parallel to a long side of the light valve, and the second direction is substantially parallel to a short side of the light valve. In the embodiment, the freeform lens group 121 includes a freeform lens 121a. However, in other embodiments, the freeform lens group 121 may also include a plurality of freeform lenses.

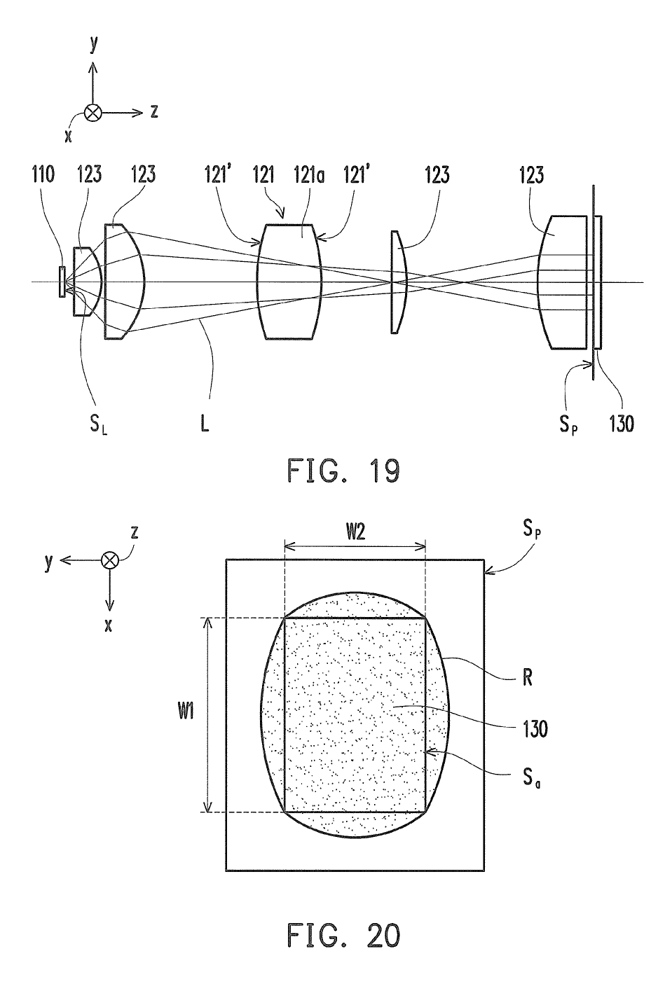

More specifically, in the embodiment, the refractive power of the freeform lens group 121 on the x-direction is not equal to the refractive power of the freeform lens group 121 on the y-direction. Moreover, the x-direction is substantially perpendicular to the y-direction, the x-direction is substantially parallel to a long side W1 of the light valve 130, and the y-direction is substantially parallel to a short side W2 of the light valve 130, as shown in FIG. 18 (FIG. 20).

It should be noted that, in the embodiment, the refractive power of the freeform lens group 121 on the first direction is less than the refractive power of the freeform lens group 121 on the second direction. For example, in the embodiment, the refractive power of the freeform lens group 121 on the x-direction is less than the refractive power of the freeform lens group 121 on the y-direction. Accordingly, the freeform lens group 121 of the present embodiment may diffuse the illumination beam L emitted by the light-emitting surface SL more on the x-direction, but not as much on the y-direction. In other words, in a beam shape R of the illumination beam L emitted by the light-emitting surface SL and projected on the projection surface Sp through the freeform lens group 121, the beam shape R is longer on the x-direction but shorter on the y-direction. Therefore, the illumination beam L emitted by the light-emitting surface SL and projected on the projection surface Sp (e.g., the x-y plane) approaches closer to the shape of the active surface Sa of the light valve 130, as shown in FIG. 18 (FIG. 20). In the present embodiment, the freeform lens 121a has a freeform surface 121′. A radius of curvature or a curvature direction of the freeform surface 121′ on the x-direction is not equal to a radius of curvature or a curvature direction of the freeform surface 121′ on the y-direction. Therefore, the refractive power of the freeform lens group 121 on the x-direction is not equal to the refractive power of the freeform lens group 121 on the y-direction. In other embodiments of the invention, a freeform lens may substitute at least one of the lenses 123.

Referring to FIGS. 14 and 15, an illumination system 200B of the present embodiment is capable of illuminating the light valve 130 on the projection surface SP. In the embodiment, the illumination system 200B includes the aforementioned light source 110 and the light uniforming and shaping module 120B. The illumination system 200B has the effects and advantages of the light source 110 and the light uniforming and shaping module 120B.

In view of the foregoing, the embodiments of the invention include at least the following advantages or effects. In the projection apparatus and the illumination system according to the embodiments of the invention, a light uniforming and shaping module is employed so the illumination beam emitted by the light-emitting surface could be more efficiently projected on the active surface of the light valve, and thereby effectively decrease the light energy loss of the light source. Moreover, by employing the light uniforming and shaping module, the defects of the beam shape of the light-emitting surface could be effectively reduced. Further, the quality of the image beam and the illumination beam projected by the projection apparatus and the illumination system is preferred. In addition, the light uniforming and shaping module according to the embodiments of the invention has a simple structure and a low production cost.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims.

What is claimed is:

1. A projection apparatus, comprising:
a light source having a light-emitting surface and capable of emitting an illumination beam;
a light uniforming and shaping module disposed on a transmission path of the illumination beam; and
a light valve disposed on a projection surface and on the transmission path of the illumination beam from the light uniforming and shaping module, wherein the light valve is capable of converting the illumination beam into an image beam,
wherein the light uniforming and shaping module is for projecting a light from each point of the light-emitting surface to a region on the projection surface, and the union of the regions projected from all the points on the light-emitting surface covers a whole active surface of the light valve.

2. The projection apparatus as claimed in claim 1, wherein the light uniforming and shaping module is for projecting the light from each point of the light-emitting surface to a region on the projection surface having an area of 40,000 or more μm2.

3. The projection apparatus as claimed in claim 1, wherein the light uniforming and shaping module comprises:
a lens array disposed on the transmission path of the illumination beam and between the light source and the light valve; and
a lens disposed on the transmission path of the illumination beam and between the lens array and the light valve.

4. The projection apparatus as claimed in claim 3, wherein a distance from the lens array to the lens is less than a distance from the lens to the light valve.

5. The projection apparatus as claimed in claim 3, wherein there is no light integration rod or another lens array disposed on the transmission path of the illumination beam between the lens array and the lens.

6. The projection apparatus as claimed in claim 1, wherein the light uniforming and shaping module comprises:
a plurality of solid light integration rods arranged in an array, wherein the solid light integration rods are disposed on the transmission path of the illumination beam and between the light source and the light valve, each of the solid light integration rods having an incident end and an emitting end opposed to each other, the illumination beam entering the solid light integration rod from the incident end and leaving the solid light integration rod from the emitting end, and the emitting end of each of the solid light integration rods has a curved surface.

7. The projection apparatus as claimed in claim 6, wherein the solid light integration rods are connected to each other at the incident end and separated from each other at the other portions.

8. The projection apparatus as claimed in claim 6, wherein the light uniforming and shaping module further comprises a lens disposed on the transmission path of the illumination beam and between the solid light integration rods and the light valve, and a distance from the solid light integration rods to the lens is less than a distance from the lens to the light valve.

9. The projection apparatus as claimed in claim 1, wherein the light uniforming and shaping module comprises a freeform lens group, wherein a refractive power of the freeform lens group on a first direction is not equal to a refractive power of the freeform lens group on a second direction.

10. The projection apparatus as claimed in claim 9, wherein the first direction is substantially perpendicular to the second direction, the first direction is substantially parallel to a long side of the light valve, and the second direction is substantially parallel to a short side of the light valve.

11. The projection apparatus as claimed in claim 10, wherein the refractive power of the freeform lens group on the first direction is less than the refractive power of the freeform lens group on the second direction.

12. An illumination system capable of illuminating a light valve on a projection surface, the illumination system comprising:
a light source having a light-emitting surface and capable of emitting an illumination beam; and
a light uniforming and shaping module disposed on a transmission path of the illumination beam so as to project the illumination beam on the light valve, wherein the light uniforming and shaping module is for projecting a light from each point of the light-emitting surface to a region on the projection surface, and the union of the regions projected from all the points on the light-emitting surface covers a whole active surface of the light valve.

13. The illumination system as claimed in claim 12, wherein the light uniforming and shaping module is for projecting the light from each point of the light-emitting surface to a region on the projection surface having an area of 40,000 or more μm2.

14. The illumination system as claimed in claim 12, wherein the light uniforming and shaping module comprises:
a lens array disposed on the transmission path of the illumination beam and between the light source and the light valve; and
a lens disposed on the transmission path of the illumination beam and between the lens array and the light valve.

15. The illumination system as claimed in claim 14, wherein a distance from the lens array to the lens is less than a distance from the lens to the light valve.

16. The illumination system as claimed in claim 14, wherein there is no light integration rod or another lens array disposed on the transmission path of the illumination beam between the lens array and the lens.

17. The illumination system as claimed in claim 12, wherein the light uniforming and shaping module comprises:
a plurality of solid light integration rods arranged in an array, wherein the solid light integration rods are disposed on the transmission path of the illumination beam and between the light source and the light valve, each of the solid light integration rods having an incident end and an emitting end opposed to each other, the illumination beam entering the solid light integration rod from the incident end and leaving the solid light integration rod from the emitting end, and the emitting end of each of the solid light integration rods has a curved surface.

18. The illumination system as claimed in claim 17, wherein the light uniforming and shaping module further comprises a lens disposed on the transmission path of the illumination beam and between the solid light integration rods and the light valve.

19. The illumination system as claimed in claim 12, wherein the light uniforming and shaping module comprises a freeform lens group, wherein a refractive power of the freeform lens group on a first direction is not equal to a refractive power of the freeform lens group on a second direction.

20. The illumination system as claimed in claim 19, wherein the first direction is substantially perpendicular to the second direction, the first direction is substantially parallel to a long side of the light valve, the second direction is substantially parallel to a short side of the light valve, and the refractive power of the freeform lens group on the first direction is less than the refractive power of the freeform lens group on the second direction.
